(19) United States
(12) Patent Application Publication
(10) Pub. No.: US 2008/0204789 A1
(43) Pub. Date: Aug. 28, 2008

(54) Systems and Methods for Identifying Physically Proximate Printers

(75) Inventor: Frankwin Hooglander, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Fort Collins, CO (US)

(21) Appl. No.: 11/678,773

(22) Filed: Feb. 26, 2007

(51) Int. Cl. H04N 1/00

(52) U.S. Cl. 358/1.15

(57) ABSTRACT

In one embodiment, a system and method pertain to identifying a need to locate printers physically proximate to a client computer, and determining which printers are physically proximate to the client computer through reference to network addresses.

### BACKGROUND

Client computers within large networks comprising many different printers are normally manually configured such that only nearby printers are presented to the user when a print command is received. For example, a network administrator may configure each client computer such that printers on the same floor as the computer or within another discrete area are presented to the user for selection when a print command is received. With such configuration, situations in which the user mistakenly selects a distant printer can be avoided.

Although such manual configuration is effective, it can be unduly time consuming, particular in large organizations given the sheer number of client computers that must be so configured.

### SUMMARY

In one embodiment, a system and method pertain to identifying a need to locate printers physically proximate to a client computer, and determining which printers are physically proximate to the client computer through reference to Internet protocol (IP) addresses.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system in which physically proximate printers can be identified.

FIG. 2 is a block diagram of an embodiment of a client computer shown in FIG. 1.

FIG. 3 is a block diagram of an embodiment of a server computer shown in FIG. 1.

FIG. 4 is a flow diagram of an embodiment of a method for printing in the system of FIG. 1.

FIG. 5 is a flow diagram of an embodiment of a method for identifying physically proximate printers and presenting them to a user for selection.

FIG. 6 is a representation of an embodiment of a database file that can be used in the method described in relation to FIG. 5.

### DETAILED DESCRIPTION

As described above, it can be time consuming to manually configure computers of a large organization so that only nearby printers are presented to the computer users when a print command is received. As described below, however, such configuration can be accomplished more easily using a system or method in which the client computers automatically identify proximately local printers and present those printers to the users for selection. In some embodiments, each client computer identifies physically proximate printers by determining a network address, such as the Internet protocol (IP) address, of the computer, determining a range of addresses that corresponds to a location in which the computer is positioned, and determining which of the printers of the network have an address that falls within the determined range. With such a system or method, nearby printers can be distinguished from distant printers.

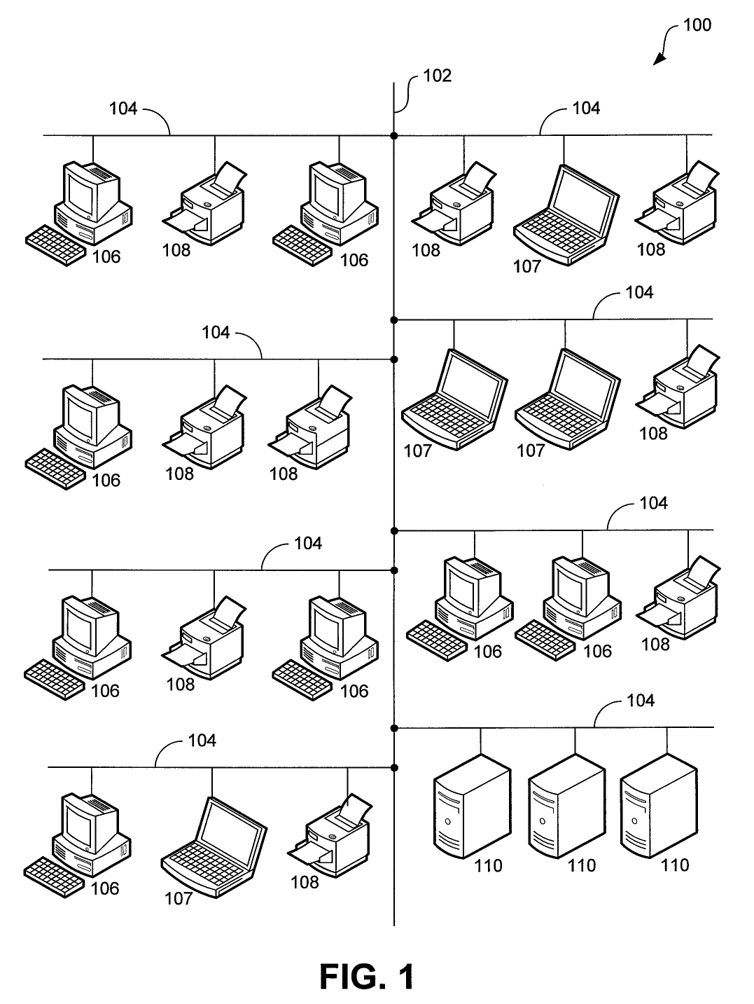

Referring now in more detail to the drawings, in which like numerals indicate corresponding parts throughout the several views, FIG. 1 illustrates an example system 100 with which nearby, i.e., local or physically proximate, printers can be identified. It is noted that although the present disclosure is described in terms of identifying nearby “printers,” the principles described herein can be extended to other devices that the user may wish to identify as being physically proximate to his or her computer.

As indicated in FIG. 1, the system 100 generally comprises a network 102. By way of example, the network 102 comprises a network of a large organization, such as a business enterprise located at one or more physical locations. Notably, the network 102 may be substantially larger than indicated in FIG. 1. Therefore, at least in some embodiments, FIG. 1 may represent just a portion of the network 102.

The network 102 comprises various branches 104. In some embodiments, each branch 104 corresponds to a different physical location within the organization. For example, each branch 104 may pertain to a given geographical site, building, or building floor. As a further example, each branch 104 may pertain to a given area of a given building floor. Regardless, each branch 104 may pertain to a given location and, therefore, the devices connected to each branch may be physically proximate enough such that a user of one device connected to a branch would be able to easily access another device connected to that same branch.

As is further indicated in FIG. 1, multiple devices are connected to the various branches 104 of the network 102. For example, multiple client computers 106 (desktop) and 107 (laptop) are connected to the network branches 104. In some embodiments, the client computers 106, 107 comprise personal computers (PCs) that generate print data to be printed as hard copy documents. In addition, multiple printers 108 are connected to the network. Given that, as indicated in FIG. 1, the printers 108 are directly connected to the network 102, as opposed to being only connected to the network via a host device, each of the printers may be described as being “network-enabled” printers. That is, each printer 108 can directly transmit and receive data via the network 102 without reliance on another device through which the network must be accessed. Although described as being “printers,” the printers 108 may comprise additional functionalities beyond only receiving print data and printing hard copy documents. For example, the printers 108 may also be capable of copying, scanning, faxing, and emailing data. In such cases, the printers 108 may be described as multi-function peripheral devices.

In addition to the client computers 106, 107 and the printers 108, server computers 110 are connected to the network 102. As described in detail below, one or more of the server computers 110 may store a database containing information that can be accessed by the client computers 106, 107 when determining which printers 108 are proximate to the client computers.

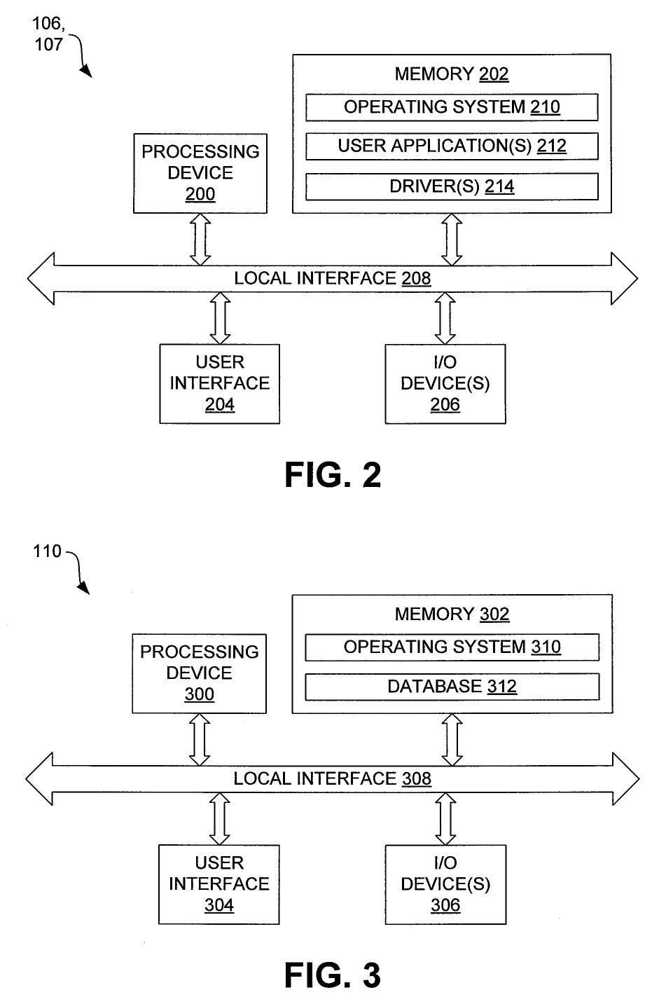

FIG. 2 is a block diagram illustrating an example architecture for one of the client computers 106 or 107. The computer 106, 107 of FIG. 2 comprises a processing device 200, memory 202, a user interface 204, and at least one I/O device 206, each of which is connected to a local interface 208.

The processing device 200 can include a central processing unit (CPU) or an auxiliary processor among several processors associated with the computer 106, 107, or a semiconductor based microprocessor (in the form of a microchip). The memory 202 includes any one of or a combination of volatile memory elements (e.g., RAM) and nonvolatile memory elements (e.g., hard disk, ROM, tape, etc.).

The user interface 204 comprises the components with which a user interacts with the computer 106, 107. The user interface 204 may comprise, for example, a keyboard, mouse, and a display, such as a cathode ray tube (CRT) or liquid crystal display (LCD) monitor. The one or more I/O devices 206 are adapted to facilitate communications with other devices and may include one or more communication components such as a modulator/demodulator (e.g., modem), wireless (e.g., radio frequency (RF)) transceiver, network card, etc.

The memory 202 comprises various programs including an operating system 210, one or more user applications 212, and one or more print drivers 214. The operating system 210 controls the execution of other programs and provides scheduling, input-output control, file and data management, memory management, and communication control and related services. The user applications 212 can comprise any application that executes on the computer 106 that generates print data for transmission to a printer for printing.

The print drivers 214 accept commands from the user application(s) and then translate those commands into specialized commands understood by a printer. In some embodiments, at least one of the print drivers 214 is a “universal” print driver, meaning that it is configured to interact with and transmit print data to various different models of printers. In such a case, a single print driver 214 may be used to print to any one of a variety of different printers. As described below, the print driver 214 is configured to automatically identify physically proximate printers. Through such identification, the print driver 214 can present only nearby printers to the user for selection, thereby avoiding situations in which the selected printer is distant from the user.

FIG. 3 is a block diagram illustrating an example architecture for one of the server computers 110 shown in FIG. 1. The server computer 110 of FIG. 3 comprises many of the same components as the client computer 106, 107 shown in FIG. 2, including a processing device 300, memory 302, a user interface 304, and at least one I/O device 306, each of which is connected to a local interface 308. In some embodiments, those components have the same or similar construction and/or function of like-named components described above in relation to FIG. 2. Accordingly, a detailed discussion of the components of FIG. 3 is not presented herein.

As indicated in FIG. 3, the memory 302 of the server computer 110 comprises an operating system 310 and a printer location database 312. The operating system 310 controls the execution of other programs and provides scheduling, input-output control, file and data management, memory management, and communication control and related services. As described in detail below, the printer location database 312 comprises various information that a print driver can access when making a determination as to which of the printers are close to a given client computer, and therefore a given user. In some embodiments, the printer location database 312 contains information about the IP address ranges of various physical areas the network serves and the IP addresses of various printers that are connected to the network. With that information, and the IP address of the client computer from which print data will be transmitted, the printer driver can, as mentioned above, present only physically proximate printers to users for selection.

Example systems having been described above, operation of the systems will now be discussed. In the discussions that follow, flow diagrams are provided. Process steps or blocks in the flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

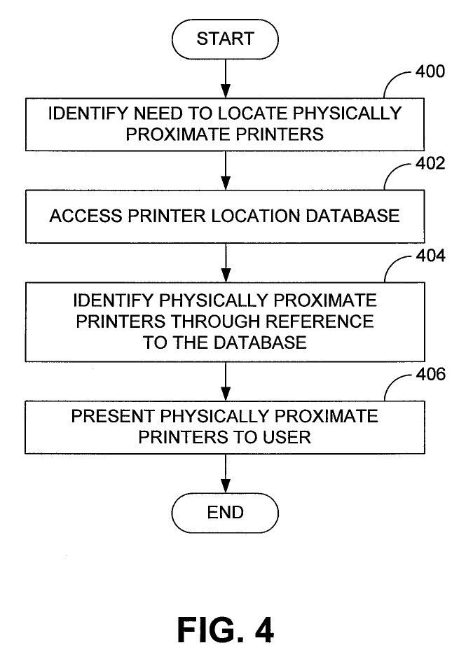

FIG. 4 is a flow diagram of an example method for printing using the system described above in relation to FIGS. 1-3. Beginning with block 400, a need to locate physically proximate printers is identified. In some cases, that need is identified in a configuration scenario in which the user is configuring his or her client computer to print to nearby printers. In other cases, that need is identified when the print command is received, that is when the user selects “print” from an appropriate user application. In the latter case, physically proximate printers can, at least in some embodiments, be detected “on the fly” each time printing is requested. Such an arrangement may be desirable in cases in which the client computer is a mobile computer, such as a laptop computer, and is connected to different points of the network as it is carried from place to place.

Upon identifying the need to locate physically proximate printers, a driver of the client computer accesses the printer location database, as indicated in block 402. By way of example, the printer location database may be accessed from a server computer on the network to which the client computer is connected. Notably, however, the printer location database may be located in other places. For example, in some embodiments the printer location database may be resident within memory of the client computer or a network printer.

Turning to block 404, the print driver identifies the printers connected to the network that are physically proximate to the client computer through reference to the printer location database. Once the physically proximate printers have been identified, the print driver can present the physically proximate printers to the user for review and/or selection, as indicated in block 406, in either the configuration or printing scenarios described above.

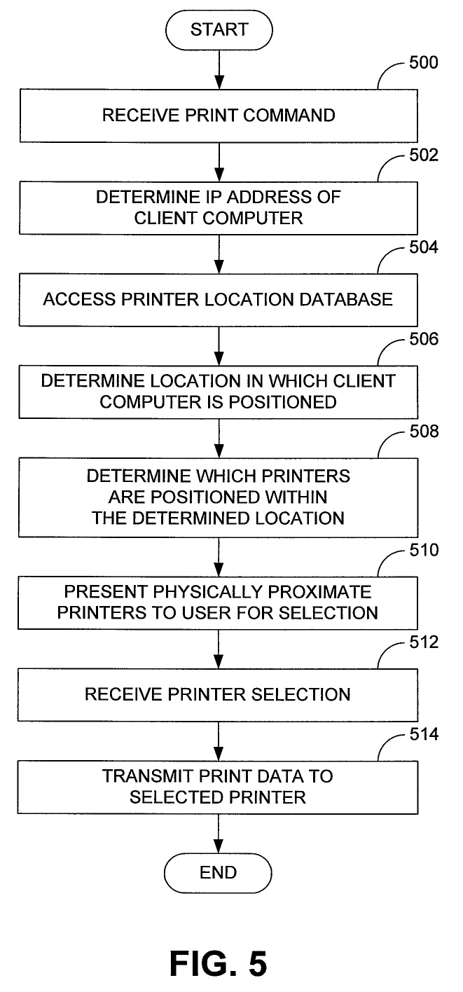

FIG. 5 is a flow diagram of an example method performed by the client computer print driver in processing a print job for a user of the client computer and identifying physically proximate printers for the user in that context. Beginning with block 500, a print command is received by the print driver. Next, the print driver determines the IP address of the client computer on which the print driver is resident and executes, as indicated in block 502. By way of example, the print driver can determine the client computer IP address by polling the operating system that executes on the client computer for that information. In such cases, the IP address will be known even if the client computer has been moved to a new location since the last time printing was performed, for instance if the client computer is a laptop computer or other portable computing device. In other embodiments, for example when the IP address is unlikely to change, the print driver can store the IP address of the client computer. The print driver further accesses the printer location database, as indicated in block 504.

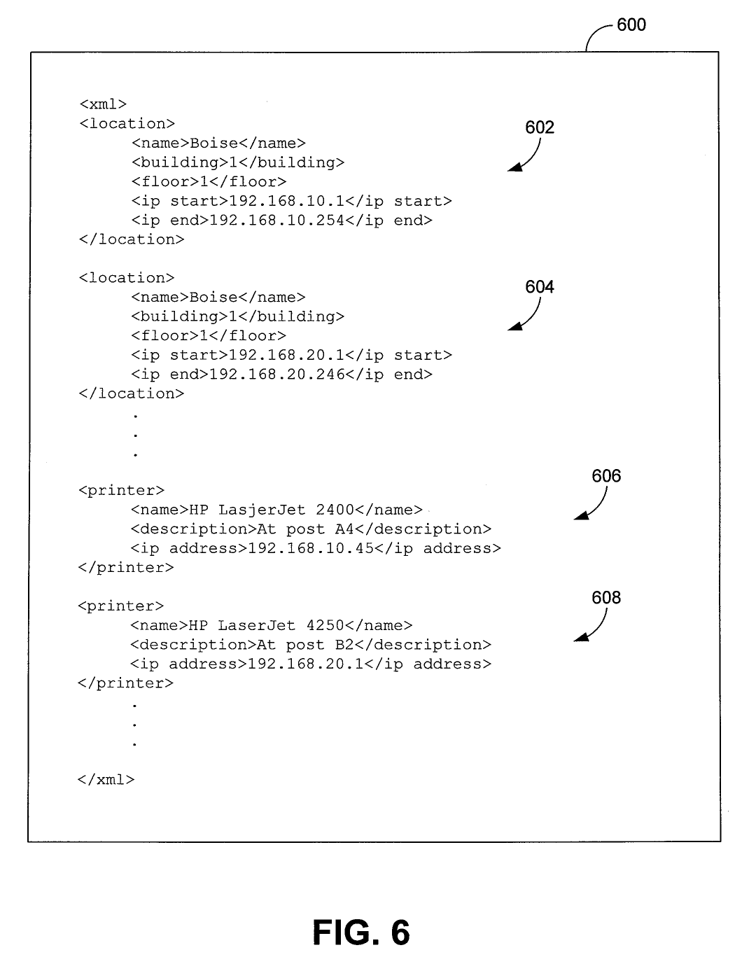

FIG. 6 illustrates an example of a printer location database 600. In the embodiment of FIG. 6, the database 600 comprises a file that contains information concerning both the locations to which the network extends as well as the printers that are available on the network. More particularly, the database 600 of FIG. 6 comprises an extensible markup language (XML) file that contains that information. Although an XML file has been specifically identified, the database may take the form of other files or other data constructs that contain the location and printer information. For example, the database can, alternatively, comprise a standard text file.

As indicated in FIG. 6, the database 600 comprises a plurality of entries that pertain to network locations and printers. In the example of FIG. 6, the database 600 has separate entries for two network locations, one being floor “1” of building “1” (reference numeral 602) and another being floor “2” of building “1” (reference numeral 604). Although only two locations are identified in the example of FIG. 6, it is noted that each location served by the network may be identified in the database 600. The database 600 further has separate entries for two network printers, one being an “HP Laserjet 2400” (reference numeral 606) and the other being an “HP Laserjet 4250” (reference numeral 608). Although only two printers are identified in the example of FIG. 6, it is noted that each printer connected to the network may be identified in the database 600.

Each location entry identifies a range of IP addresses that pertain to that particular location. Therefore, in this example, the devices located on first floor of building 1 in the city of “Boise” have IP addresses in the range of 192.168.10.1 to 192.168.10.254, and the devices located on the second floor of building 1 in Boise have IP addresses in the range of 192.168.20.1 to 192.168.20.246. Each printer entry identifies the IP address of that particular printer. Therefore, in this example, the HP Laserjet 2400 has an IP address of 192.168.10.45 and the HP Laserjet 4250 has an IP address of 192.168.20.1. From the IP address information contained in the example database 600, it can be appreciated that the HP Laserjet 2400 is within the range of IP addresses that pertains to the first floor of building 1 and the HP Laserjet 4250 is within the range of IP addresses that pertains to the second floor of building 1. It can therefore be presumed that the HP Laserjet 2400 is located on the first floor of building 1 and that the HP Laserjet 4250 is located on the second floor of building 1.

With reference back to FIG. 5, the print driver can then determine the location in which the client computer is positioned, as indicated in block 506. That determination can be made by comparing the client computer IP address obtained in block 502 with the ranges of IP addresses for the various locations identified in the database. Using the example of FIG. 6, if the client computer has an IP address of 192.168.20.143, the client computer is located on the second floor of the first building as that IP address is within the range of 192.168.20.1 to 192.168.20.246.

Referring to block 508, the print driver determines which printers are positioned within the determined location. That determination is made through comparison of the IP addresses of the printers identified in the printer location database with the IP address range for the determined location, the second floor of building 1 in the above example. In keeping with that example, the second printer identified in the database 600 of FIG. 6, the HP Laserjet 4250, is positioned in the same location of the client computer and therefore can be presumed to be physically proximate to the client computer.

Once the printers positioned in the same location of the client computer are determined, the print driver can present those printers to the user for selection, as indicated in block 510. In keeping with the above-described example, the HP Laserjet 4250 would be presented to the user. Next, the print driver receives the printer selection of the user (block 512) and then transmits print data to the selected printer for printing (block 514).

Although particular embodiments of systems and methods have been described in the foregoing, those embodiments are mere examples of the disclosed systems and methods. Therefore, other embodiments are possible and are considered to fall within the scope of the present disclosure.

The following are claimed:

1. A method comprising:
identifying a need to locate printers physically proximate to a client computer; and
determining which printers are physically proximate to the client computer through reference to network addresses.

2. The method of claim 1, wherein identifying a need occurs responsive to receiving a print command with a print driver.

3. The method of claim 1, wherein determining which printers are physically proximate comprises determining which printers are physically proximate with a print driver.

4. The method of claim 1, wherein determining which printers are physically proximate comprises determining an IP address of the client computer.

5. The method of claim 4, wherein determining which printers are physically proximate further comprises identifying IP address ranges associated with physical locations of a network.

6. The method of claim 5, wherein determining which printers are physically proximate further comprises identifying a physical location in which the client computer is positioned by comparing the client computer IP address and the IP address ranges.

7. The method of claim 6, wherein determining which printers are physically proximate further comprises identifying IP addresses of available printers and determining which printers have IP addresses within the IP range of the identified physical location.

8. The method of claim 7, further comprising only presenting the printers having IP addresses within the IP address range of the identified physical location to a user of the client computer.

9. A printing system comprising:
means for determining which printers are physically proximate to a client computer through reference to network addresses.

10. The system of claim 9, wherein the means for determining which printers are physically proximate comprise means for determining an IP address of the client computer.

11. The system of claim 10, wherein the means for determining which printers are physically proximate further comprise means for identifying IP address ranges associated with physical locations of a network and IP addresses of available printers.

12. The system of claim 11, wherein the means for determining which printers are physically proximate further comprise means for comparing the IP address of the client computer and the IP addresses of the printers with the IP address ranges to identify a location in which the client computer and printers are positioned.

13. A print driver stored on a computer-readable medium, the print driver comprising:
logic configured to determine which printers are physically proximate to a client computer through reference to network addresses.

14. The print driver of claim 13, wherein the logic configured to determine which printers are physically proximate comprises logic configured to determine an IP address of the client computer.

15. The print driver of claim 14, wherein the logic configured to determine which printers are physically proximate further comprises logic configured to determine IP address ranges that pertain to physical locations of a network.

16. The print driver of claim 15, wherein the logic configured to determine which printers are physically proximate further comprises logic configured to identify a physical location in which the client computer is positioned by comparing the client computer IP address and the IP address ranges.

17. The print driver of claim 16, wherein the logic configured to determine which printers are physically proximate further comprises logic configured to identify IP addresses of available printers and determine which printers have IP addresses within the IP address range of the identified physical location.

18. The print driver of claim 17, further comprising the logic configured to only present the printers having IP addresses within the identified physical location to a user of the client computer.

19. A print method comprising:
receiving with a print driver a command entered by a user on a client computer;
determining with the print driver an Internet protocol (IP) address of the client computer;
accessing a database with the print driver that identifies locations and IP address ranges that pertain to those locations, as well as printers and IP addresses that pertain to those printers;
determining with the print driver a location in which the client computer is positioned by comparing the client computer IP address with the IP address ranges;
determining with the print driver which printers are located within the determined location by comparing the printer IP addresses with the IP address range of the determined location;
presenting with the print driver the printers that are located within the determined location to the user;
receiving with the print driver selection of a printer; and
transmitting with the print driver print data of the user to the selected printer.

20. The method of claim 19, wherein accessing a database comprises the print driver accessing a file resident on a distant computer or printer via a network.
